(19) United States
(12) Patent Application Publication
(10) Pub. No.: US 2006/0153227 A1
(43) Pub. Date: Jul. 13, 2006

(54) Apparatus and method for transmitting information data in a wireless communication system

(75) Inventors: In-Seok Hwang, Seoul (KR); Soon-Young Yoon, Seoul (KR); Sang-Hoon Sung, Suwon-si (KR); Jae-Hee Cho, Seoul (KR); Hoon Huh, Seongnam-si (KR); Jang-Hoon Yang, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/330,756

(22) Filed: Jan. 12, 2006

(30) Foreign Application Priority Data
Jan. 12, 2005 (KR) 3051/2005

(51) Int. Cl. H04Q 7/00

(52) U.S. Cl. 370/465; 370/328

(57) ABSTRACT

A system and method for transmitting control information and data to a mobile station in a communication system using adaptive antenna technology defined in a broadband wireless communication system. In a method for transmitting and receiving information data in the wireless communication system, a base station separates information data to be transmitted into control information and user data, applies different modulation and coding schemes to the control information and the user data, and transmits the information data to an associated mobile station. The mobile station identifies the modulation and coding schemes of the information data received from the base station and demodulates a total of the information data according to the modulation and coding schemes, or independently demodulates the control information and the data according to the modulation and coding schemes.

### PRIORITY

This application claims priority under 35 U.S.C. § 119 to an application entitled “Apparatus and Method for Transmitting Information Data in a Wireless Communication System” filed in the Korean Intellectual Property Office on Jan. 12, 2005 and assigned Serial No. 2005-3051, the contents of which are incorporated herein by reference.

### BACKGROUND OF THE INVENTION

1. Field of the Invention

The present invention generally relates to a broadband wireless access (BWA) communication system, and more particularly to an apparatus and method for transmitting information data including control information and data in an adaptive antenna system (AAS) of a broadband wireless communication system.

2. Description of the Related Art

Currently, extensive research is being conducted to provide users with services based on various qualities of service (QoS) at a high transmission rate of about 100 Mbps, in fourth-generation (4G) communication systems serving as next-generation communication systems. In the current 4G-communication system, research is actively being conducted to support a high-speed service for ensuring mobility and QoS in broadband wireless access (BWA) communication systems such as wireless local area network (LAN) and metropolitan area network (MAN) communication systems. Typical 4G-communication systems are Institute of Electrical and Electronics Engineers (IEEE) 802.16a and 802.16e communication systems.

The IEEE 802.16a and 802.16e communication systems use orthogonal frequency division multiplexing and/or orthogonal frequency division multiple access (OFDM/OFDMA) to support a broadband transmission network for a physical channel of the wireless MAN system. The IEEE 802.16a communication system considers a state in which a subscriber station (SS) is fixed. In other words, the IEEE 802.16a communication system considers only a single cell structure, and not SS mobility. However, the IEEE 802.16e communication system is used to support SS mobility in the IEEE 802.16a communication system. An SS with mobility is referred to as a mobile station (MS).

The IEEE 802.16e communication system extends a cell service area using multiple antennas and uses a space division multiple access (SDMA) scheme for increasing a total capacity. To use the SDMA scheme, an uplink adaptive antenna system (AAS) preamble is defined in the standard such that channel quality information (CQI) of MSs can be correctly estimated.

A base station (BS) generates beams using a correlation between spatial channels estimated through preambles such that interference between users, i.e., MSs, can be minimized. When the beams are generated using the correlation, interference of signals of the MSs interfering with other neighbor MSs is reduced, such that data can be correctly decoded.

FIG. 1 schematically illustrates a broadband wireless communication system using a conventional SDMA scheme.

Referring to FIG. 1, a BS 101 allocates, to different MSs, identical time and frequency resources to be simultaneously used in a first spatial channel transmitted through a first beam 102 and a second spatial channel transmitted through a second beam 103. To allocate the identical time and frequency resources to the different MSs, the BS 101 generates a plurality of spatially divided beams, for example, the first beam 102 and the second beam 103.

FIG. 2 schematically illustrates the frame structure of the conventional broadband wireless communication system.

Referring to FIG. 2, a frame is divided into a downlink (DL) frame 201 and an uplink (UL) frame 202. The DL frame 201 includes a DL preamble region, a frame control header (FCH) region, a DL-MAP region, a UL-MAP region, a region of a plurality of AAS preambles and a region of a plurality of DL Bursts.

The DL preamble region is used to transmit a synchronization signal for synchronization acquisition between a transmitter and a receiver, i.e., a preamble sequence. The FCH region is used to transmit information indicating a length and coding scheme of a DL-MAP. A position and a modulation and coding scheme (MCS) of the FCH region are fixed. The DL-MAP region is used to transmit a DL-MAP message. The UL-MAP region is used to transmit a UL-MAP message referred to in the DL-MAP message. A concrete description of information elements (IEs) included in the DL-MAP and UL-MAP messages is omitted here, for the sake of conciseness.

The UL frame 202 includes a region of a plurality of AAS preambles and a region of a plurality of UL Bursts.

On the other hand, the conventional broadband wireless communication system transmits an AAS private MAP in a DL message to support the AAS. The AAS private MAP (hereinafter, the private MAP) includes allocation information and AAS frame configuration information for a specific user.

The AAS private MAP message defined in the broadband wireless communication system defines information about DL and UL band allocation regions in the next frame to be demodulated by a specific MS and defines control information including system operational information for the AAS. This control information is connected to a data burst in an information bit level in the current frame for efficient transmission. The control information and the data burst are transmitted through an antenna after undergoing a coding and modulation process in an identical level and a beamforming process.

FIG. 3 schematically illustrates a conventional process for transmitting a private MAP message.

FIG. 3 illustrates an example in which a DL-MAP 310 of the n-th frame (Frame n) designates a private MAP 320 of an AAS zone. Referring to FIG. 3, the private MAP 320 is configured by AAS_Private_DL-MAP for designating a DL allocation region and AAS_Private_UL-MAP for designating a UL allocation region. AAS_Private_DL-MAP and AAS_Private_UL-MAP designate a DL allocation region 330 and a UL allocation region 340 of the Frame n+1, respectively.

As described with reference to FIG. 2, a DL frame includes a DL-MAP message corresponding to a message for describing all resource allocations in the frame. Because system common control information is transmitted in the DL-MAP message, it is broadcast to all MSs without directivity. A DL/UL AAS zone corresponds to a zone in which the BS uses an adaptive antenna for forming a directional beam on an MS-by-MS basis, and is defined in the DL-MAP message in an OFDM symbol unit.

The private MAP message indicates allocation information on the MS-by-MS basis in the AAS zone. If the private MAP is first used, it is pointed to in the DL-MAP transmitted in a non-AAS zone. That is, the private MAP 320 of FIG. 3 is pointed to in the DL-MAP 310.

After receiving and decoding the private MAP 320, the MS demodulates and decodes the DL allocation region 330 in the (n+1)-th fFrame n+1. Through these operations, the MS separates the DL allocation region 330 into a private MAP burst 331 containing allocation information of the Frame n+2 in the information bit level and a traffic data burst 332 of the Frame n+1. Moreover, the MS transmits a UL data burst 341 through the UL allocation region 340.

FIG. 4 is a block diagram schematically illustrating the structure of the conventional transmitter for transmitting a private MAP in a broadband wireless communication system.

Referring to FIG. 4, the transmitter includes a channel encoder 410, a symbol mapper 420, a beamformer 425, a plurality of serial-to-parallel (S/P) converters 430, a subchannel allocator 440, a plurality of inverse fast Fourier transform (IFFT) processors 450, a plurality of parallel-to-serial (P/S) converters 460, a plurality of guard interval (GI) inserters 470, a plurality of digital-to-analog (D/A) converters 480 and a plurality of radio frequency (RF) processors 490.

First, allocation information 400 of a private MAP message 401 and a data burst 402 to be transmitted is input to the channel encoder 410. When receiving the allocation information 400, the channel encoder 410 encodes the allocation information 400 in a preset coding scheme and then outputs the encoded allocation information to the symbol mapper 420. Here, the coding scheme may be all kinds of encoding scheme, e.g., a turbo coding or convolutional coding scheme based on a coding rate.

The symbol mapper 420 modulates encoded information bits output from the channel encoder 410 on the basis of a preset modulation scheme, generates a modulated symbol and outputs the modulated symbol to the beamformer 425. Here, the modulation scheme is a Quadrature Phase Shift Keying (QPSK) scheme, a Quadrature Amplitude Modulation (QAM) scheme or a 16-QAM scheme.

Conventionally, the transmitter modulates and encodes the allocation information 400 configured by one packet, i.e., the private MAP message 401 and the data burst 402, in an identical modulation and coding scheme (MCS) level.

The beamformer 425 forms beams to be transmitted through a plurality of adaptive antennas, and outputs modulated symbols corresponding to the formed beams to the S/P converters 430.

The S/P converters 430 receive the modulated symbols, convert the received modulated symbols in a parallel fashion, and output the parallel symbols to the IFFT processors 450. At this time, the subchannel allocator 440 allocates subchannels to the modulated symbols in a subchannel allocation scheme based system setup, and outputs an allocation result to the IFFT processors 450. Then, the IFFT processors 450 receive the modulated symbols output from the S/P converters 430, perform N-point IFFTs and output IFFT signals to the P/S converters 460. The P/S converters 460 receive the signals output from the IFFT processors 450, convert the received signals in a serial fashion and output the serial signals to the GI inserters 470.

The GI inserters 470 receive the serial signals output from the P/S converters 460, insert GI signals into the received signals, and output, to the D/A converters 480, the signals into which the GI signals have been inserted. Here, the GI signal is inserted to remove interference between an OFDM symbol transmitted in the previous OFDM symbol time and an OFDM symbol transmitted in the current OFDM symbol time when the OFDM symbols are transmitted in the OFDM communication system.

The D/A converters 480 receive the time domain OFDM signals from the GI inserters 470, convert the received time domain OFDM signals to analog signals and output the analog signals to the RF processors 490. The RF processors 490 convert the signals output from the D/A converters 480 to RF signals such that the RF signals can be transmitted to air. The RF processors 490 transmit the RF signals to air through transmit (Tx) antennas.

When receiving the allocation information 400 from the BS, MSs, for example, MS 0 and MS 1, separate the private MAP message 401 and the data burst 402 in an information bit level by performing identical demodulation and decoding operations on the allocation information 400, i.e., the private MAP message 401 and the data burst 402. When receiving a signal from the BS's transmitter, the MSs recover an information bit stream by demodulating and decoding a DL allocation region in a demodulation and decoding scheme that is the inverse of the modulation and coding scheme applied in the BS. Then, the MSs separate, from the recovered information bit stream, system configuration change information, control information associated with as an UL/DL band allocation region of the next frame, and a DL data burst transmitted in the current frame.

In the conventional technology as described above, the control information and the DL data burst have the same coverage according to the private MAP message transmission scheme. In the conventional technology, variation in a wireless environment may occur due to a channel quality measurement error and report delay. Therefore, a problem arises wherein important control information such as system configuration change information may not be received.

When hybrid automatic retransmission request (HARQ) technology is used to transmit data for which an expected reception error rate is set high regardless of stability under an assumption that a data burst is actively retransmitted to cope with the above-described uncertain wireless environment variation, control information for the HARQ operation must be more robust than the data burst. However, this cannot be supported in the conventional method for transmitting an AAS private MAP message.

### SUMMARY OF THE INVENTION

Accordingly, the present invention has been designed to solve the above and other problems occurring in the prior art. Therefore, it is an object of the present invention to provide an apparatus and method for transmitting and receiving a data burst and control information including a private MAP for each user through different modulation and coding schemes in a broadband wireless communication system.

It is another object of the present invention to provide an adaptive antenna system (AAS) private MAP message for transmitting, to each user, control information and system configuration change information included in a private MAP that is more robust than a downlink data burst.

It is another object of the present invention to provide an apparatus and method that can separate downlink data and control information to be transmitted to a mobile station and transmit the downlink data and control information through different modulation and coding schemes in a broadband wireless communication system.

It is yet another object of the present invention to provide an apparatus and method that can recover downlink data and control information based on different modulation and coding schemes transmitted from a base station in a broadband wireless communication system.

In accordance with an aspect of the present invention, there is provided a method for transmitting and receiving information data in a wireless communication system, including: separating information data to be transmitted from a base station into control information and data, applying different modulation and coding schemes to the control information and the data, and transmitting the information data to an associated mobile station; and identifying the modulation and coding schemes of the information data received from the base station in the mobile station, and demodulating a total of the information data according to the modulation and coding schemes, or independently demodulating the control information and the data according to the modulation and coding schemes.

In accordance with another aspect of the present invention, there is provided a method for transmitting allocation information of an adaptive antennas system (AAS) zone in an AAS, including separating control information and downlink data to be transmitted to a mobile station, performing different modulation and coding processes for the control information and the data, and transmitting, to the mobile station, the control information and the data to which the different modulation and coding processes have been applied.

In accordance with another aspect of the present invention, there is provided a method for receiving allocation information of an adaptive antenna system (AAS) zone in an AAS, including identifying modulation and coding schemes of a control information region and an user data region from a total allocation region of information data transmitted from a base station, decoding control information according to a first modulation and coding scheme allocated to the control information of the allocation region, and decoding new data according to a second modulation and coding scheme allocated to the data of the allocation region.

In accordance with yet another aspect of the present invention, there is provided a system for transmitting and receiving allocation information of an adaptive antenna system (AAS) zone in a wireless communication system, including a base station for dividing information data to be transmitted to a mobile station into control information and data, applying different modulation and coding schemes to the control information and the data, and transmitting the information data to the mobile station, and the mobile station for identifying the modulation and coding schemes of the information data received from the base station, and demodulating a total of the information data according to the modulation and coding schemes, or independently demodulating the control information and the data according to the modulation and coding schemes.

### BRIEF DESCRIPTION OF THE DRAWINGS

The above and other objects and advantages of the present invention will be more clearly understood from the following detailed description taken in conjunction with the accompanying drawings, in which:

FIG. 1 schematically illustrates a broadband wireless communication system using a conventional space division multiple access (SDMA) scheme;

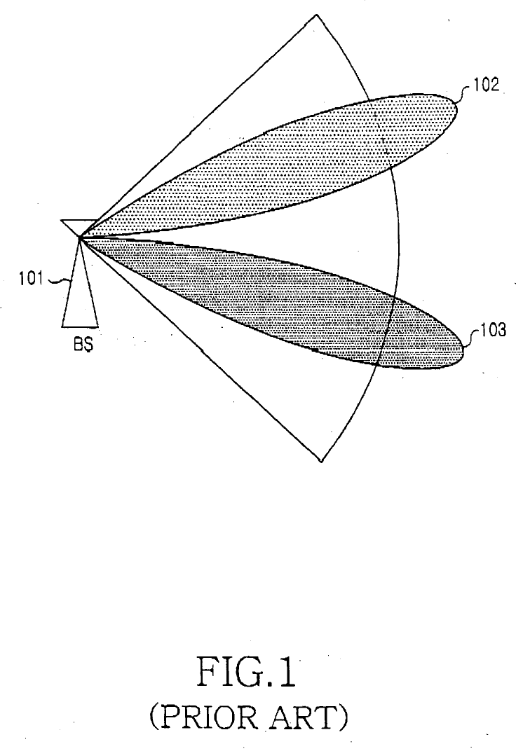

FIG. 2 schematically illustrates a frame structure of the conventional broadband wireless communication system;

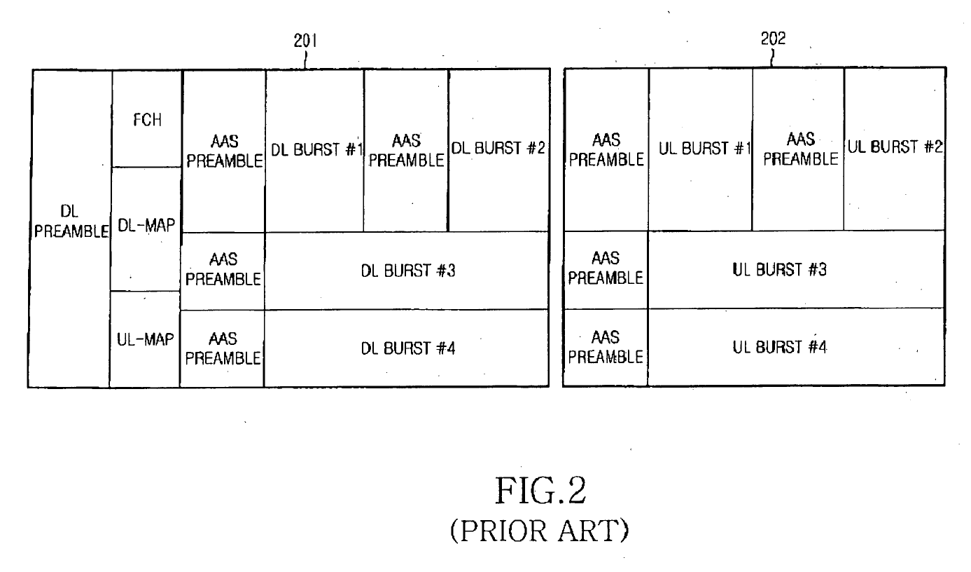

FIG. 3 schematically illustrates a conventional process for transmitting a private MAP message;

FIG. 4 is a block diagram schematically illustrating a transmitter structure of the conventional broadband wireless communication system;

FIG. 5 is a block diagram schematically illustrating a transmitter structure of a broadband wireless communication system in accordance with the present invention;

FIG. 6 illustrates a scheme for expressing an allocation region in the broadband wireless communication system in accordance with the present invention;

FIG. 7 illustrates the coverage of control information and a data burst in accordance with the present invention; and

FIG. 8 is a flowchart illustrating a reception process in a mobile station of the broadband wireless communication system in accordance with the present invention.

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for the sake of clarity and conciseness.

The present invention proposes an apparatus and method for transmitting data in a broadband wireless access (BWA) communication system. Specifically, the present invention relates to an apparatus and method for transmitting system operational information and band allocation information in an adaptive antenna system (AAS) of a broadband wireless communication system.

The present invention also relates to a method for transmitting, to a specific user or mobile station (MS), data and a private MAP serving as an operational message including system operational information and band allocation information from a base station (BS) system based on the AAS defined in a conventional broadband wireless communication system. In addition, the present invention relates to an apparatus and method for transmitting and receiving a private MAP and data processed in different modulation and coding scheme (MCS) levels.

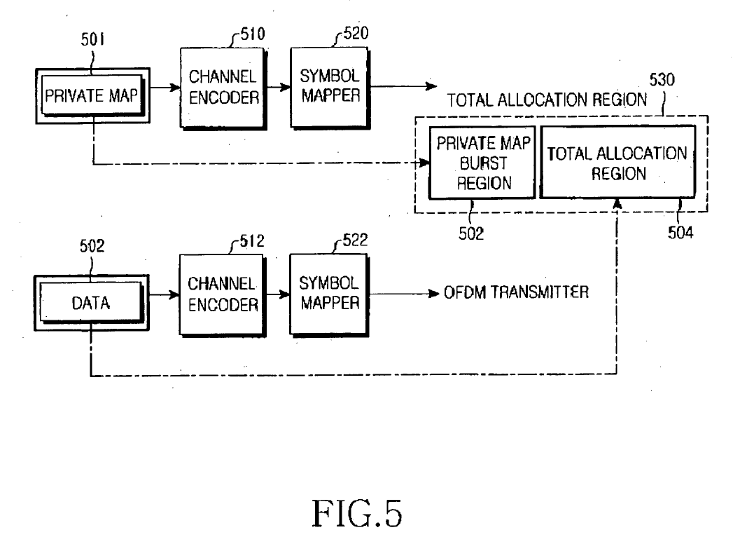

FIG. 5 is a block diagram schematically illustrating a transmitter structure of a broadband wireless communication system in accordance with the present invention.

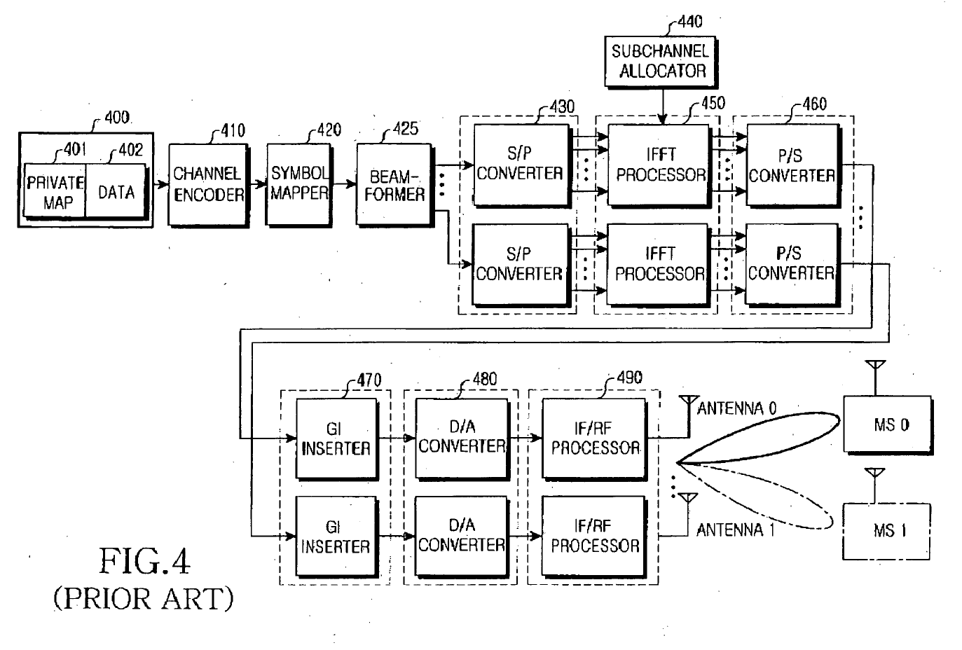

FIG. 5 illustrates an MCS for a private MAP in accordance with the present invention. A structure of the input stage of the transmitter illustrated in FIG. 4 is separated such that a private MAP transmission concept illustrated in FIG. 5 can be explained.

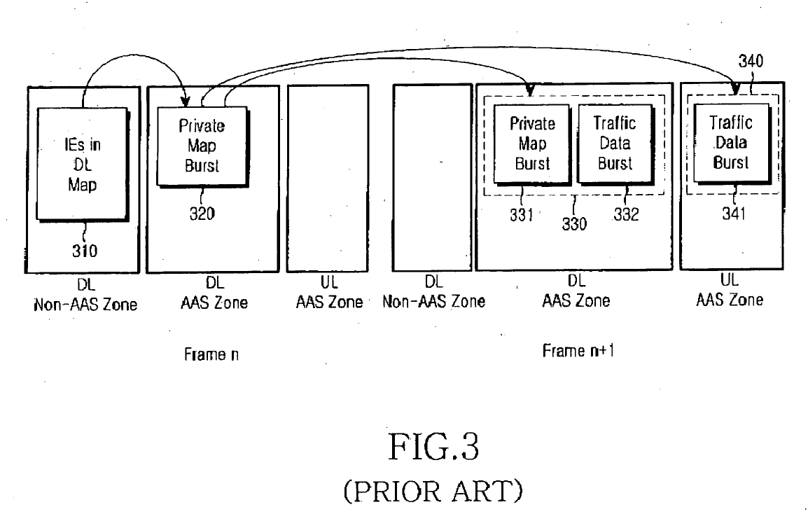

As illustrated in FIG. 5, a total allocation region 530 in accordance with an embodiment of the present invention has the same function as the total allocation region 330 of FIG. 3. The private MAP message 401 and the data burst 402 of FIG. 4 are combined into one unit as in the total allocation region 330 of FIG. 3, and are conventionally processed in the same MCS level. However, the present invention processes a private MAP message 501 and a data burst 502 in different modulation and coding processes. In accordance with the present invention, a private MAP region and an user data region are separated from a total allocation region 530 of FIG. 5, and different MCS levels are allocated to the private MAP region and the user data region. The private MAP region and the user data region in the different MCS levels are transmitted.

For example, the private MAP message 501 undergoes the first modulation and coding through a channel encoder 510 and a symbol mapper 520, while the data burst 502 undergoes the second modulation and coding through a channel encoder 512 and a symbol mapper 522. Because a process subsequent to the channel encoders 510 and 512 and the symbol mappers 520 and 522 is the same as described with reference to FIG. 4, its detailed description is omitted here. The channel encoders 510 and 512 and the symbol mappers 520 and 522 are conceptually separated from each other for a better explanation of the present invention. It should be noted that the channel encoders 510 and 512 or the symbol mappers 520 and 522 are preferably provided in one configuration as illustrated in FIG. 4. However, the present invention is not limited to this structure. Of course, the channel encoder and the symbol mapper for the private MAP and the channel encoder and the symbol mapper for the data burst can be separately configured as illustrated in FIG. 5.

After the various modulation and coding processes and a beamforming process occur, the private MAP message and the data burst are transmitted through an antenna. In this case, the private MAP message and the data burst are transmitted in an identical beam pattern after undergoing the various modulation and coding processes in accordance with the present invention.

In the present invention, the various modulation and coding processes are performed for the private MAP message and the data burst, such that a coverage extension gain can be obtained through a directional beamforming gain, and also, control information can be stabilized. These advantages will be clearly described with reference to Table 1.

TABLE 1

| | | Beamforming gain | | Control info |
|---|---|---|---|---|
| | | Allocation | Data | Protection |
| Scheme/feature | | info | burst | level control |
| Prior art | DL-MAP | No | Yes | No |
| | Private MAP | Yes | Yes | No |

| | | | |
|---|---|---|---|
| Improved private MAP scheme | Yes | Yes | Yes |

Table 1 shows features in accordance with the present invention. From Table 1, a beamforming gain is absent because allocation information based on a conventional DL-MAP is transmitted in a non-AAS zone and a protection level for the allocation information cannot be controlled on an MS-by-MS basis. Beamforming gains for both the allocation information and the data burst in the private MAP transmitted in the AAS zone can be obtained, and a protection level of the allocation information is the same as that of the data burst. In accordance with the present invention, the allocation information undergoes a more robust MCS than the data burst of the private MAP.

Next, a stable private MAP message of the broadband wireless communication system in accordance with the present invention will be described.

Table 2 shows an AAS_Private_DL-MAP message. Here, only information elements (IEs) newly added to the AAS_Private_DL-MAP in accordance with the present invention will be described in detail.

TABLE 2

| | | Size | |
|---|---|---|---|
| Syntax | | (bits) | Notes |
| Reduced_AAS_Private_DL-MAP( ) { | | | |
| | Compressed map indicator | 3 | Set to 0b110 for compressed format |
| | UL-MAP appended | 1 | 1 = reduced UL Private map is |
| | | | appended. |
| | Compressed Map Type | 2 | Shall be set to 0b11 for reduced private |
| | | | map |
| | Multiple IE | 1 | 1 = Multiple IE Mode. |
| | Reserved | 1 | Shall be set to zero |
| | if (Multiple IE) { | | |

| | |
|---|---|
| NUM IE | 8 |

}
for (ii=1:NUM IE) {

| Periodicity | 2 | 00 = single command, not periodic, or |
|---|---|---|
| | | terminate periodicity. Otherwise, repeat |
| | | DL and UL allocations once per r |
| | | frames, where r = 2⁽ⁿ⁻¹⁾, where n is the |
| | | decimal equivalent of the periodicity |
| | | field. |
| CID Included | 1 | 1 = CID included. |
| | | The CID shall be included in the first |
| | | compressed private MAP if it was |
| | | pointed to by a DL-MAP IE with |
| | | INC_CID == 0 or by a DL-MAP IE |
| | | with a multicast CID. |
| DCD Count Included | 1 | 1 = DCD Count included. |
| | | The DCD count is expected to be the |
| | | same as in the broadcast map that |
| | | initiated the private map chain. The |
| | | DCD count can be included in the |
| | | private map if it changes. |
| PHY modification Included | 1 | 1 = included. |
| CQICH Control Indicator | 1 | 1 = CQICH control information |
| | | included. |
| Encoding Mode | 2 | Encoding for DL traffic burst |
| | | 0b00: No HARQ |
| | | 0b01: Chase Combining HARQ |
| | | 0b10: Incremental Redundancy HARQ |
| | | 0b11: Conv. Code Incremental |
| | | Redundancy |
| Separate MCS Enabled | 1 | Separate coding applied for reduced |
| | | AAS_Private_MAP and DL data burst |
| If (Separate MCS Enabled) { | | Specifies coding for the next private |

| | | map in the allocation specified by this |
|---|---|---|
| | | private map |
| Duration | 10 | Slot duration for reduced AAS Private |
| | | MAP |
| DIUC | 4 | Modulation & Coding Level |
| Repetition Coding Indication | 2 | 0b00: No repetition |

0b01: Repetition of 2
0b10: Repetition of 4
0b11: Repetition of 6

}
if (CID Included) {

| | | |
|---|---|---|
| CID | 16 | Must be a unicast CID |

}
If (CQICH Control Indicator == 1) {

| Allocation Index | 6 | CQICH subchannel index within Fast- |
|---|---|---|
| | | feedback region marked with UIUC = 0 |
| Report Period | 3 | Reporting period indicator (in frames) |
| Frame offset | 3 | Start frame offset for initial reporting |
| Report Duration | 4 | Reporting duration indicator |
| CQI Measurement Type | 2 | 0b00 - CINR measurement based upon |
| | | DL allocation |
| | | 0b01 - CINR measurement based upon |
| | | DL frame preamble |
| | | 0b10, 0b11 - Reserved |
| Reserved | 2 | Shall be set to zero |

}
if (DCD Count Included) {

| | | |
|---|---|---|
| DCD Count | 8 | Matches the value of the configuration |

change count of the DCD, which
describes the downlink burst profiles
that apply to this map.

}
if (PHY modification Included) {

| Preamble Select | 1 | 0 = Frequency shifted preamble |
|---|---|---|
| | | 1 = Time shifted preamble |
| Preamble Shift Index | 4 | Updated preamble shift index to be used |
| | | starting with the frame specified by the |
| | | Frame Offset. |
| Pilot Pattern Modifier | 1 | 0: Not Applied |
| | | 1: Applied |
| | | Shall be set to 0 if PUSC AAS zone |
| Pilot Pattern Index | 2 | pilot pattern used for this allocation (see |

| | | section 8.4.6.3.3 (AMC), 8.4.6.1.2.6 |
|---|---|---|
| | | (TUSC)): |
| | | 0b00 - Pilot pattern #A |
| | | 0b01 - Pilot pattern #B |
| | | 0b10 - Pilot pattern #C |
| | | 0b11 - Pilot pattern #D |
| } | | |
| DL Frame Offset | 3 | Defines the frame in which the burst is |

located. A value of zero indicates an
allocation in the subsequent frame.

if (current zone permutation is FUSC

| or optional FUSC) { | | | |
|---|---|---|---|
| | Zone symbol offset | 8 | The offset of the OFDMA symbol in |

| | | which the zone containing the burst |
|---|---|---|
| | | starts, measured in OFDMA symbols |
| | | from beginning of the downlink frame |
| | | referred to by the Frame Offset. |
| } | | |
| OFDMA Symbol Offset | 8 | Starting symbol offset referenced to DL |
| | | preamble of the downlink frame |
| | | specified by the Frame Offset. |
| If (current zone permutation is AMC, | | AMC (2 × 3 type), TUSC1 and TUSC2 |

| TUSC1 or TUSC2) { | | | all have triple symbol slot lengths |
|---|---|---|---|
| | Subchannel offset | 8 | |
| | No. OFDMA triple symbol | 5 | Number of OFDMA symbols is given |
| | | | in multiples of 3 symbols |
| | No. subchannels | 6 | |

} Else {

| | |
|---|---|
| Subchannel offset | 6 |
| No. OFDMA Symbols | 7 |
| No. subchannels | 6 |

| } | | |
|---|---|---|
| DIUC/N_{EP} | 4 | DIUC for Encoding Mode 0b00, 0b01, |
| | | 0b11 |
| | | N_{EP} for Encoding Mode 0b10 |
| If (HARQ Enabled) { | | Encoding Mode 0b00, 0b10, 0b11 |

| DL HARQ ACK bitmap | 1 | HARQ ACK for previous UL burst |
|---|---|---|
| ACK Allocation Index | 6 | ACK channel index within HARQ ACK |
| | | region |
| ACID | 4 | HARQ channel ID |
| AI_SN | 1 | HARQ Seq. Number Indicator |
| If (IR Type) { | | Incremental Redundancy |

| N_{SCH} | 4 | Applied for Encoding Mode 0b10 |
|---|---|---|
| SPID | 2 | Applied for Encoding Mode 0b10 and |
| | | 0b11 |
| Reserved | 2 | |

}

| } | | |
|---|---|---|
| Repetition Coding Indication | 2 | 0b00 - No repetition coding |

0b01 - Repetition coding of 2 used
0b10 - Repetition coding of 4 used
0b11 - Repetition coding of 6 used

If (UL-MAP appended) {

| | |
|---|---|
| Reduced_AAS_Provate_UL-MAP ( ) | variable |

| } | |
|---|---|
| Reserved | 3 |

| } | | |
|---|---|---|
| Nibble Padding | variable | Padding depends upon HARQ options. |
| CRC-16 | 16 | |

}

As shown in Table 2, the AAS_Private_DL-MAP message includes fields of Separate MCS Enabled, Duration, and Repetition Coding Indication. The Separate MCS Enabled field indicates that modulation and coding processes are applied for the private MAP and the data burst separated from each other. The Duration field indicates the total number of slots allocated to the private MAP for a sum of AAS_Private_DL-MAP and AAS_Private_UL-MAP. The DIUC field indicates a scheme for processing a physical channel of a DL data burst to be transmitted, such as an MCS. That is, the DIUC field indicates an MCS level such as QPSK 3/4 or 16-QAM 1/2. The Repetition Coding Indication field is used to indicate more robust modulation and coding through a codeword repeat. For example, the Repetition Coding Indication field indicates that a coding scheme of QPSK 1/8 is applied if QPSK 1/2 is set and the number of repeats is 4.

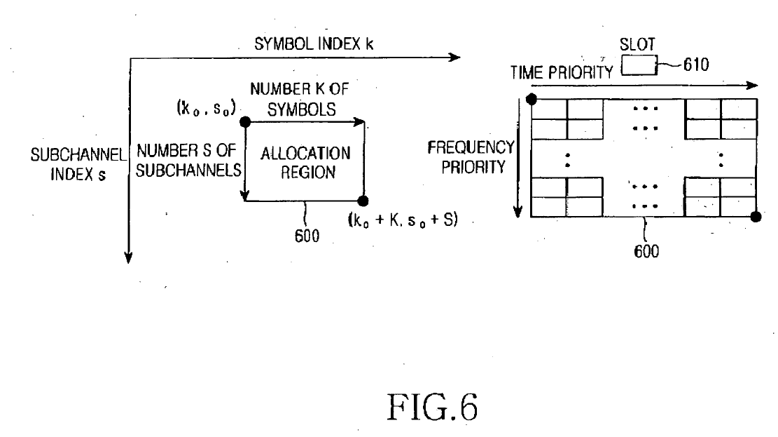

To help in understanding the private MAP in accordance with the present invention, an allocation region expression scheme defined in the broadband wireless communication system will be described with reference to FIG. 6.

In FIG. 6, a description of an allocation region in an identical permutation zone for configuring a logical subchannel is used when an allocation region of a DL frame is designated by start coordinates (k₀, s₀), the number K of symbols, and the number S of subchannels in a two-dimensional plane configured by a logical subchannel index s and a symbol index k. In the present invention, the total allocation region 530 of FIG. 5 corresponds to the allocation region 600 of FIG. 6.

When the allocation region 600 is designated as described above, it can be divided in a slot unit 610 corresponding to a time-frequency space of one subchannel. Because a DL allocation region designated in the DL AAS private MAP is separated into a private MAP region and an user data region as illustrated in FIG. 5 in accordance with the present invention, some of the slots for the allocation region are used to transmit the fields for indicating the number of slots belonging to the private MAP region, and a downlink interval usage code (DIUC) and Repetition Coding Indication associated with the MCS, and the remaining slots are used to transmit data. In a method for indexing the slots, the frequency has a priority in the DL and the time has a priority in the UL.

The MCS for a data burst to be transmitted in the remaining slots except slots used for the private MAP among all allocated slots uses the DIUC and Repetition Coding Indication or uses {N_{EP}, N_{SCH}} corresponding to associated control information and HARQ Control_IE when HARQ operates. {N_{EP}, N_{SCH}} is an identifier for identifying a size of information bits to be transmitted and a slot size. The HARQ Control_IE is a field for indicating a retransmission number and an HARQ channel number.

In an uplink frame of the broadband wireless communication system, a specific permutation region is divided in a symbol unit. Slots of an associated permutation region are arranged in the time priority in one dimension, and are indicated by a slot offset and slot duration in an AAS zone. Because a private MAP is transmitted only in the DL in the present invention, AAS_Private_UL-MAP is not varied. A detailed description of the AAS_Private_UL-MAP message is omitted here.

To successfully receive one data burst in the HARQ, a plurality of transmission opportunities is given. Preferably, the MS accumulates reception energy through demodulation and decoding for the plurality of transmission opportunities, determines whether reception is successful, and makes a retransmission request until the reception is successfully performed.

If the AAS private MAP message is conventionally transmitted through the same MCS as that for the data burst, a probability in which an error occurs in HARQ control information associated with an associated data burst becomes high when the MS receives the private MAP message and the data burst, such that an HARQ operation is unstable. As a result, a gain of the HARQ operation cannot be obtained.

However, the present invention transmits the control information independent of the data burst, thereby stably transmitting the control information and ensuring an HARQ gain of the data burst.

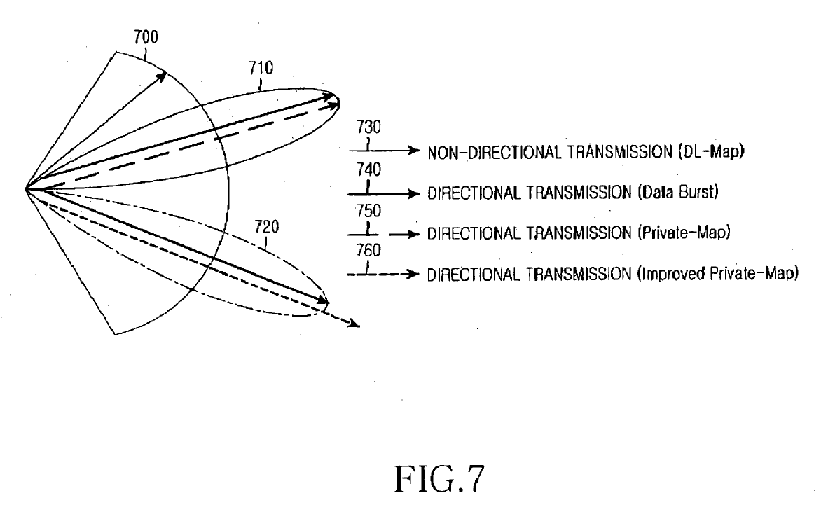

If the private MAP message corresponding to the control information and the data burst undergo different coding processes, the control information can be transmitted more stably than the data burst. When technology for actively transmitting the data burst such as HARQ is used, the effect of stability can be further increased. This stability effect will be described in more detail with reference to FIG. 7.

FIG. 7 illustrates the coverage of control information and a data burst in accordance with the present invention.

FIG. 7 illustrates a beam pattern 700 of a DL MAP at the time of non-directional transmission and beam patterns 710 and 720 at the time of directional transmission. Reference numerals 730 to 760 denote coverage, respectively. As illustrated in FIG. 7, the coverage can be adjusted according to an improved private MAP to which a more robust modulation and coding level than that for the data burst is applied in accordance with the present invention, such that control information can be stably transmitted.

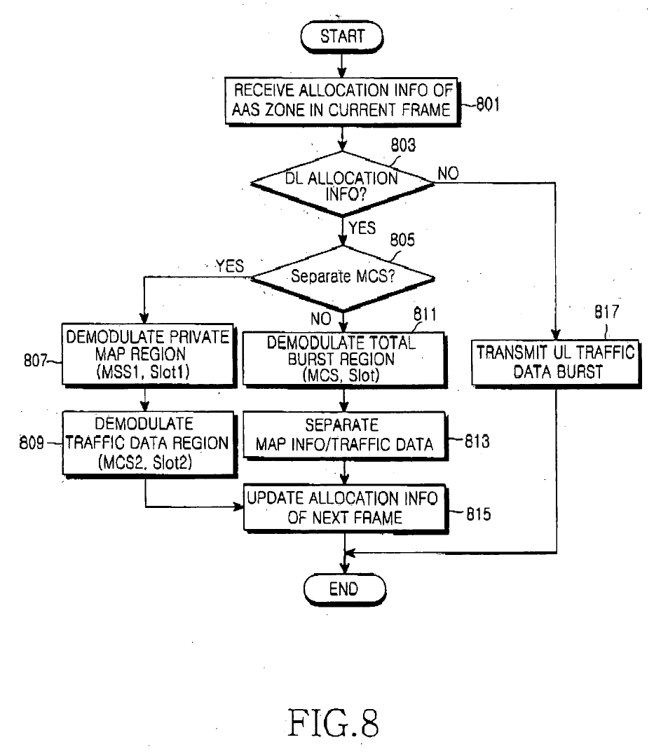

FIG. 8 is a flowchart illustrating a reception process in an MS of the broadband wireless communication system in accordance with the present invention. For convenience of explanation, it is assumed that one allocation region, for example, the region 530 of FIG. 5, is allocated to a DL AAS zone.

Referring to FIG. 8, the MS receives allocation information of an AAS zone transmitted in the current frame in step 801 and proceeds to step 803. In step 803, the MS determines whether the received allocation information is DL or UL allocation information.

If it is determined that the received allocation information is the UL allocation information, the MS transmits an associated burst, i.e., a UL traffic data burst, in step 817. However, if it is determined that the received allocation information is the DL allocation information, the MS identifies MCS levels of an user data region and a private MAP region of the DL allocation information in step 805. That is, the MS determines whether different MCS levels have been applied for the private MAP region and the user data region in step 805. If the private MAP region and the user data region form one group and the allocation information indicates that the same MCS level has been applied as a determination result, the MS proceeds to step 811. However, if the private MAP region and the user data region are separated from each other and the allocation information indicates that different MCS levels have been applied as a determination result, the MS proceeds to step 807.

If the same MCS level has been applied to the private MAP region and the user data region as a determination result in step 805, the MS demodulates a total burst region in step 811 and then proceeds to step 813. The MS separates the private MAP information and the traffic data in an information bit level in step 813 and then proceeds to step 815.

If the different MCS levels have been applied to the private MAP region and the user data region as a determination result in step 805, the MS independently demodulates the private MAP region and the user data region and then proceeds to step 815. Upon determining that the different MCS levels have been applied, the MS demodulates the private MAP region in step 807 and demodulates the user data region in step 809.

Because the different MCS levels are applied to the private MAP and the data in the present invention, the private MAP region and the traffic user data region are independently demodulated. For example, assuming that the number of subchannels allocated to the private MAP and the user data region correspond to Slot 1 and Slot 2 and MCSs applied to the private MAP and the traffic data are MCS 1 and MCS 2, respectively, the MS demodulates an associated burst region mapped to the MCS set in the BS, thereby obtaining traffic data received in the current frame and allocation information of the next frame.

As is apparent from the above description, the present invention provides an apparatus and method for transmitting information data in a wireless communication system that apply different modulation and coding schemes (MCSs) to an adaptive antenna system (AAS) private MAP message of control information and a data burst when a base station system using adaptive antenna technology defined in a broadband wireless communication system sends an operational message to a specific mobile station, thereby more stably transmitting the control information. The effect of stability can be further increased in a system for aggressively transmitting a data burst in a communication system using a hybrid automatic retransmission request (HARQ) scheme. In accordance with the present invention, the coverage of a base station can be adjusted according to an improved private MAP to which a more robust modulation and coding level than that for the data burst is applied, such that stable control information can be transmitted. As described above, the various modulation and coding processes are performed for the private MAP message and the data burst, such that a coverage extension gain can be obtained through a directional beamforming gain, and control information can be stabilized.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for transmitting and receiving information data in a wireless communication system, comprising the steps of:
separating information data to be transmitted from a base station into control information and user data, applying different modulation and coding schemes to the control information and the user data, and transmitting the information data to an associated mobile station; and
identifying the modulation and coding schemes of the information data received from the base station in the mobile station, and demodulating a total of the information data according to the modulation and coding schemes, or independently demodulating the control information and the user data according to the modulation and coding schemes.

2. The method of claim 1, further comprising the steps of:
dividing a total allocation region of the information data to be transmitted to the mobile station into the control information and the user data in the base station;
allocating a first modulation and coding scheme to the control information of the total allocation region; and
allocating a second modulation and coding scheme to the user data of the total allocation region.

3. The method of claim 1, further comprising the steps of:
identifying a total allocation region of the information data transmitted from the base station in the mobile station;
demodulating the control information according to a first modulation and coding scheme allocated to the control information of the allocation region; and
demodulating the user data according to a second modulation and coding scheme allocated to the user data of the allocation region.

4. The method of claim 1, wherein the control information comprises a private MAP message.

5. The method of claim 1, wherein the base station indicates a differentiation between the control information and the user data to the mobile station through an adaptive antenna system (AAS) private MAP message.

6. The method of claim 5, wherein the private MAP message comprises a Separate Modulation and Coding Scheme (MCS) Enabled field for indicating whether the modulation and coding schemes are differently applied to the control information and the user data or not.

7. The method of claim 5, wherein the private MAP message comprises a Duration field for indicating a number of slots allocated to the private MAP message.

8. The method of claim 7, wherein the number of slots comprises a number of subchannels allocated to a control information region and an user data region of a total allocation region.

9. The method of claim 7, wherein the private MAP message comprises a Downlink Interval Usage Code (DIUC) field for indicating a modulation and coding level of downlink data to be transmitted.

10. The method of claim 7, wherein the private MAP message comprises a Repetition Coding Indication field for indicating a coding scheme based on a number of repeats of a set coding scheme.

11. A method for transmitting allocation information of an adaptive antennas system (AAS) zone in an AAS, comprising the steps of:
separating control information and downlink data to be transmitted to a mobile station;
performing different modulation and coding processes for the control information and the downlink data; and
transmitting, to the mobile station, the control information and the downlink data to which the different modulation and coding processes have been applied.

12. The method of claim 11, wherein the separating step comprises the steps of:
dividing a total allocation region in a slot unit corresponding to a time-frequency space;
dividing a downlink allocation region designated in the control information into a private MAP region and an user data region;
allocating, to the private MAP region, a number of slots for system setup among all slots of the total allocation region; and
allocating, to the user data region, a number of remaining slots except the slots allocated to the private MAP region among all the slots of the total allocation region.

13. The method of claim 11, wherein the step of performing the modulation and coding processes comprises the steps of:
dividing a total allocation region of information data to be transmitted to the mobile station into the control information and the downlink data;
allocating a first modulation and coding scheme to the control information of the total allocation region; and
allocating a second modulation and coding scheme to the information data of the total allocation region.

14. The method of claim 11, wherein the control information comprises an AAS private MAP message.

15. The method of claim 14, wherein the private MAP message comprises a field for indicating that a private MAP burst and a data burst are separated and modulation and coding are applied to the separated private MAP burst and the data burst.

16. The method of claim 14, wherein the private MAP message comprises a field for indicating a number of slots belonging to the private MAP region among all the slots of the total allocation region.

17. The method of claim 14, wherein the private MAP message comprises a field for indicating a scheme for processing a physical channel of a downlink data burst.

18. The method of claim 14, wherein the private MAP message comprises a Repetition Coding Indication field for applying a modulation and coding scheme according to a system situation.

19. The method of claim 11, further comprising the step of:
transmitting the control information and a data burst that have undergone the different modulation and coding processes, in an identical beam pattern.

20. A method for receiving allocation information of an adaptive antenna system (AAS) zone in an AAS, comprising the steps of:
identifying modulation and coding schemes of a control information region and an user data region from a total allocation region of information data transmitted from a base station;
decoding control information according to a first modulation and coding scheme allocated to the control information of the allocation region; and
decoding new data according to a second modulation and coding scheme allocated to data of the allocation region.

21. The method of claim 20, wherein the step of identifying the modulation and coding schemes comprises the steps of:
receiving allocation information of an AAS zone transmitted in a current frame in a mobile station;
determining if the allocation information is downlink or uplink allocation information;
identifying the modulation and coding schemes applied to the user data region and the control information region of the downlink allocation information if the received allocation information is the downlink allocation information; and
identifying that the control information region and the user data region are separated from each other and different modulation and coding schemes are applied.

22. The method of claim 21, further comprising the step of:
transmitting an uplink data burst to the base station if the allocation information is the uplink allocation information.

23. The method of claim 21, further comprising the step of:
updating allocation information of a next frame after demodulating a total burst region when it is identified that the control information region and the user data region are configured in one group and an identical modulation and coding scheme is applied.

24. The method of claim 20, wherein the decoding step comprises the steps of:
separating the control information region and the user data region when it is identified that different modulation and coding schemes are allocated to the control information region and the user data region;
decoding the control information according to a first modulation and coding scheme set in the separated control information region;
decoding the new data according to a second modulation and coding scheme set in the separated user data region; and
updating allocation information of a next frame after decoding the control information and the new data.

25. A system for transmitting and receiving allocation information of an adaptive antenna system (AAS) zone in a wireless communication system, comprising:
a base station for dividing information data to be transmitted to a mobile station into control information and user data, applying different modulation and coding schemes to the control information and the user data, and transmitting the information data to the mobile station; and
the mobile station for identifying the modulation and coding schemes of the information data received from the base station, and demodulating a total of the information data according to the modulation and coding schemes, or independently demodulating the control information and the user data according to the modulation and coding schemes.

26. The system of claim 25, wherein the base station divides a total allocation region of the information data to be transmitted to the mobile station into the control information and the user data, allocates a first modulation and coding scheme to the control information of the total allocation region, and allocates a second modulation and coding scheme to the user data of the total allocation region.

27. The system of claim 25, wherein the mobile station identifies a total allocation region of the information data transmitted from the base station, demodulates the control information according to a first modulation and coding scheme allocated to the control information of the allocation region, and demodulates the user data according to a second modulation and coding scheme allocated to the user data of the allocation region.

28. The system of claim 25, wherein the control information comprises an AAS private MAP message.

29. The system of claim 28, wherein the private MAP message comprises a Separate Modulation and Coding Scheme (MCS) Enabled field for indicating that the modulation and coding schemes are allocated.

30. The system of claim 28, wherein the private MAP message comprises a Duration field for indicating a number of slots allocated to the private MAP message.

31. The system of claim 30, wherein the number of slots comprises the number of subchannels allocated to a control information region and an user data region of a total allocation region.

32. The system of claim 28, wherein the private MAP message comprises a Downlink Interval Usage Code (DIUC) field for indicating a modulation and coding level of a downlink data burst to be transmitted.

33. The system of claim 28, wherein the private MAP message comprises a Repetition Coding Indication field for applying a modulation and coding scheme according to a system situation.

34. The system of claim 25, wherein the base station reports division between the control information and the user data to the mobile station through an AAS private MAP message.

35. A method for transmitting information in an adaptive antenna system (AAS) communication system, comprising the steps of:
making, by a base station (BS), an AAS private down link (DL) MAP message including a Separate MCS Enabled field for indicating whether modulation and coding schemes are differently applied to a control information and an user data or not; and
transmitting the AAS private DL MAP message to a mobile station (MS).

36. The method of claim 35, wherein the AAS private DL MAP message comprises a Repetition Coding Indication field for indicating a coding scheme based on a number of repeats of a set coding scheme when the Separate MCS Enabled field indicating that the modulation and coding schemes are differently applied to the control information and the user data.

37. The method of claim 35, wherein the AAS private DL MAP message comprises a Downlink Interval Usage Code (DIUC) field for indicating a modulation and coding level when the Separate MCS Enabled field indicating that the modulation and coding schemes are differently applied to the control information and the user data.
